(19) United States
(12) Patent Application Publication
(10) Pub. No.: US 2025/0203615 A1
(43) Pub. Date: Jun. 19, 2025

(54) POWER REDUCTION IN PROCESSING PHYSICAL LAYER OF A WIRELESS SYSTEM

(71) Applicant: Marvell Asia Pte Ltd, Singapore (SG)

(72) Inventor: Atul Kumar, Doddakannelli (IN)

(21) Appl. No.: 18/981,510

(22) Filed: Dec. 14, 2024

Related U.S. Application Data
(60) Provisional application No. 63/610,988, filed on Dec. 15, 2023.

(51) Int. Cl. H04W 72/1273; H04W 72/0446; H04W 72/1268; H04W 72/52

(52) U.S. Cl. CPC H04W 72/1273; H04W 72/0446; H04W 72/1268; H04W 72/52

(57) ABSTRACT

A system includes a controller configured to receive a cellular configuration data and a network traffic data. The cellular configuration data is associated with a plurality of cells within a wireless network. The system includes an on-chip shared memory configured based on the cellular configuration data into a plurality of memory bank groups. Each memory bank group includes a number of memory banks. A first subset of memory bank groups is associated with an uplink slot. A second subset of memory bank groups is associated with a downlink slot. The first subset of memory bank groups associated with the uplink slot is clocked off in response to the network traffic data being associated with a downlink slot. The second subset of memory bank groups associated with the downlink slot is clocked off in response to the network traffic data being associated with an uplink slot.

### CROSS-REFERENCE TO RELATED APPLICATIONS

This application claims the benefit and priority to the U.S. Provisional Patent Application No. 63/610,988 filed on Dec. 15, 2023, which is incorporated herein in its entirety.

### BACKGROUND

While power consumption of smartphones has been critical to the success of a wireless network due to limited power of battery, power consumption by a base station in a wireless network such as 4G has typically been ignored and very few efforts have been made to reduce that power consumption. However, power consumption by the base station has increased substantially since the advent of 5G wireless communication system for a number of different reasons including the higher frequency used for 5G wireless communication system in comparison to 4G wireless communication system. Moreover, power consumption has increased since the advent of 5G wireless communication because the higher frequencies of 5G wireless network has necessitated a significant increase in the number of base stations to provide sufficient coverage due to mid to high-frequency band characteristics of the signal. For example, approximately three times as many base stations are used in 5G wireless communication in comparison to 4G wireless communication in order to achieve a similar coverage. Increase in power consumption leads to inefficiencies in the system as well as resulting in higher cost of operation.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts an example of a wireless network according to one aspect of the present embodiments.

FIG. 2 depicts an example of base station processing data according to one aspect of the present embodiments.

FIGS. 3A-3D depict an example of managing power associated with a shared memory in a static configuration of a wireless network according to one aspect of the present embodiments.

FIGS. 4A-4D depict an example of managing power associated with a shared memory in a dynamic configuration of a wireless network according to one aspect of the present embodiments.

FIG. 5 depicts an example of a base station with shared memory for processing data according to one aspect of the present embodiments.

FIG. 6 depicts an example of a processing unit of a base station in a wireless network according to one aspect of the present embodiments.

FIGS. 7A-7B depict an example of managing power for the processing unit in a base station of a wireless network according to one aspect of the present embodiments.

FIG. 8 depicts an illustrative flow diagram for managing power associated with a shared memory in a processor of a base station according to one aspect of the present embodiments.

FIG. 9 depicts an illustrative flow diagram for managing power associated with a processor of a base station according to one aspect of the present embodiments.

### DETAILED DESCRIPTION

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Before various embodiments are described in greater detail, it should be understood that the embodiments are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein. It should also be understood that the terminology used herein is for the purpose of describing the certain concepts, and the terminology is not intended to be limiting. Unless defined otherwise, all technical and scientific terms used herein have the same meaning as commonly understood in the art to which the embodiments pertain.

There is a need to reduce power consumption by the base stations in wireless networks such as 5G given the significant increase in the number of base stations and their power consumption associated with increases in signal frequencies. Reducing power consumed by base stations in a 5G wireless network (deployed for macro cells, micro cells, and/or small cells) results in reducing the cost associated with operating such wireless networks.

According to some embodiments, a 5G wireless network may adapt virtual radio access network (RAN) and/or open radio access network (ORAN) where higher layer stacks are processed on a cloud server and where the physical (PHY) layer processing is offloaded to a hardware component such as Peripheral Component Interconnect (PCI) card or PCI express (PCIe). It is appreciated that the PHY layer processing may be performed simultaneously for multiple cells within the wireless network interfacing with one or more radio units.

Typically, PHY layer processing and the radio frequency (RF) in the wireless network consumes most of the power, e.g., approximately 70% of the power consumed, in the system. Accordingly, efforts in reducing power consumption related to PHY layer processing and/or RF in the system will significantly reduce power consumption of the system as a whole.

Resources, e.g., Physical Resource Blocks (PRBs), memory, buffer space, processing resources for signal processing and computing controller workload (such as accelerators and/or digital signal processors (DSPs)), etc., are generally allocated to cells, e.g., in a 5G network, by a base station when a particular cell is being configured. It is appreciated that a 5G wireless network is a dynamic load system and supports a wide variety of use cases, e.g., broadband, Internet of Things (IoT), ultra-low latency, etc., where each may have their own unique data workflow. Conventionally, resources were allocated based on the cell configuration (statically) and independent of the load (traffic cell), resulting in inefficient power consumption. As such, managing power consumption associated with PHY layer processing based on the load (that may be dynamic) is an effective way to reduce power consumption in the PHY layer processing. For example, placing components, e.g., memory components, processor, etc., in a lower power mode (e.g., sleep mode, clock gating to turn off, etc.) when not in use may be an effective tool in reducing power consumption.

A radio frame in a wireless network may be divided into a number of subframes where each subframe may be divided into a number of slots where each slot may be used to transmit a number of orthogonal frequency-division multiplexing (OFDM) symbols (i.e., multiple symbols may be transmitted by one user or multiple symbols by multiple users). For a non-limiting example, in a 5G wireless communication, 100 MHz may be used with 30 KHz sub-carrier spacing (SCS), the slot duration may be 500 μs and may be used to communicate 14 OFDM symbols.

According to some embodiments, a base station may allocate a certain number of uplink slots in the shared memory (by one or more processors, one or more accelerators, and/or one or more DSPs) for uplink data, a certain number of downlink slots in the shared memory (by one or more processors, one or more accelerators, and/or one or more DSPs) for downlink data, and a certain number of slots in the shared memory (by one or more processors, one or more accelerators, and/or one or more DSPs) that are flexible (may be allocated to uplink or downlink).

Generally, allocation of shared memory for uplink, downlink, or flexible slots is based on a cell configuration. For example, most users are involved with downloading content as opposed to uploading content and as such the base station may allocate 7 slots of a shared memory for downlink, 2 slots of shared memory for uplink, and 1 slot of the shared memory as a flexible slot. It is appreciated that a 5G wireless network may be deployed as a time division duplex (TDD) mode, i.e., either transmits or receives on cells. Slots allocated for uplink during downlink consume power even though they are not being utilized, thereby resulting in inefficient power consumption. Similarly, slots allocated for downlink during uplink consume power even though they are not being utilized, thereby resulting in inefficient power consumption. In other words, slots allocated by the base station based on the cell configuration (e.g., 7 downlink slots, 2 uplink slots, and 1 flexible slot) independent of load result in a waste of power.

To manage power consumption and reduce waste, a shared memory (for one or more processors, one or more accelerators, and/or one or more DSPs) used in PHY layer processing may be partitioned into multiple memory banks. A number of memory banks may form a group (e.g., a row of memory banks, a column of memory banks, etc.) that may be allocated as uplink slot, downlink slot, or flexible slot. Forming memory banks enables the memory banks to be clocked off, if needed, thereby reducing power consumption.

In one nonlimiting example, during uplink, the base station may clock off (gating) the unused memory bank groups, e.g., memory banks allocated to downlink, memory banks allocated to downlink and certain groups of memory banks allocated to uplink based on load, etc. In one nonlimiting example, during downlink, the base station may clock off (gating) the unused memory bank groups, e.g., memory banks allocated to uplink, memory banks allocated to uplink and certain groups of memory banks allocated to downlink based on load, etc. As such, unused memory banks no longer consume power, thereby reducing the power usage by the base station and more particularly by the shared memory used in PHY layer processing.

In some embodiments, one or more processors, e.g., central processing units (CPUs), at a base station are used for PHY layer processing. The one or more CPUs may process data and assign one or more jobs to one or more hardware accelerators or to assign one or more jobs to one or more DSPs. In the conventional system, the one or more CPUs remain in their fully on power mode even during the time that the one or more CPUs are not processing any data, e.g., during the time which the one or more hardware accelerators are processing the one or more jobs, during the time which the one or more DSPs are processing the one or more jobs, etc. This results in a waste of power. As such, according to some embodiments, the one or more CPUs are transitioned into a lower power mode (e.g., sleep mode) after completion of processing (e.g., after assignment of jobs to one or more accelerators, after assignment of jobs to one or more DSPs, etc.) in order to reduce power consumption. For example, one or more CPUs may be processing data for duration of 2 symbols to assign jobs to one or more accelerators and/or to one or more DSPs and then transition into a lower power mode (e.g., sleep mode) for the remainder of the symbols, e.g., 12 symbols, etc.) within a given slot that includes 14 symbols. As such, power usage by the one or more CPUs is significantly reduced.

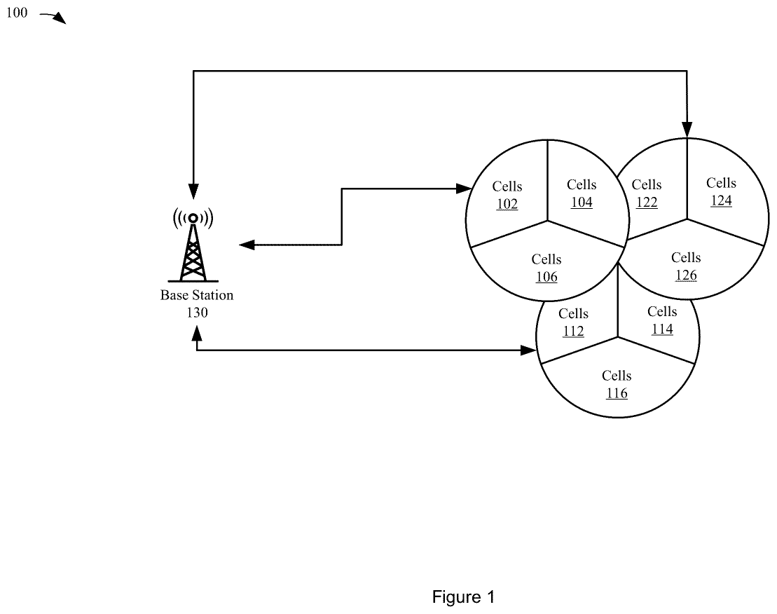

FIG. 1 depicts an example of a wireless network 100 according to one aspect of the present embodiments. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

The wireless network 100 may include a plurality of cells, e.g., cells 102, 104, 106, 112, 114, 116, 122, 124, and 126. Each cell may include multiple cells. For example, cell 102 may include two cells, three cells, etc. The each of the cells 102-126 is wirelessly coupled to a base station 130. The base station 130 may include one or more servers, one or more PCI cards, etc., for processing the PHY layer of the data. The wireless network 100 adapts virtual RAN and/or ORAN architecture.

It is appreciated that the base station 130 includes one or more processors to process the data and assign jobs to one or more DSPs and/or one or more hardware accelerators. It is appreciated that the base station 130 may allocate resources, e.g., slots, for uplink, downlink, etc., based on the cell configuration data, e.g., configuration data associated with cell 102, etc. For example, the base station 130 may allocate 7 slots for downlink, 2 slots for uplink, and 1 slot as a flexible slot to the cells 102-126 based on the configuration data associated with the cells (e.g., received from the cells). The allocated flexible slot may be dynamically allocated between uplink/downlink as needed. It is appreciated that the higher layer processing associated with the communication between the base station 130 and the cells, e.g., cells 102-126, may be offloaded to a cloud server while the PHY layer processing may be offloaded to a PCI card.

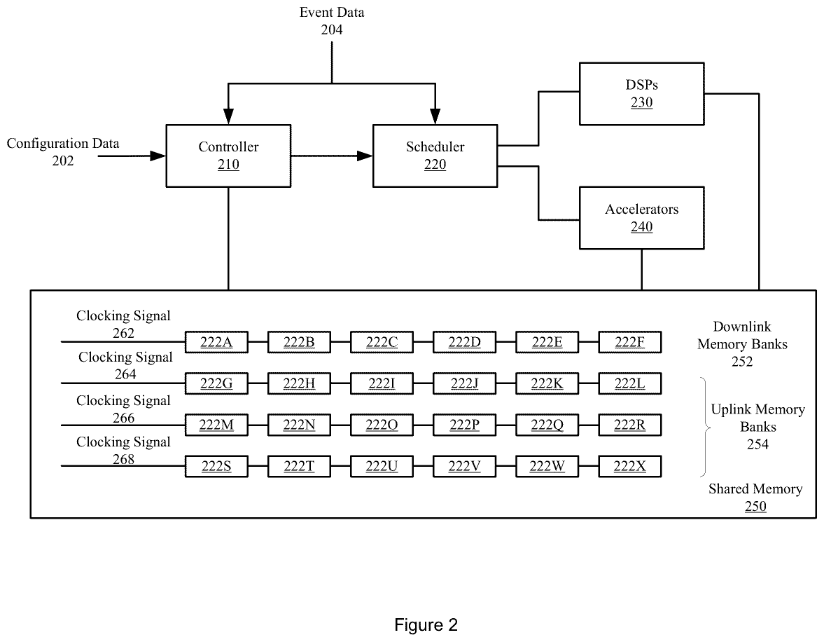

FIG. 2 depicts an example of base station processing data according to one aspect of the present embodiments. The base station includes a controller 210, scheduler 220, DSPs 230, accelerators 240, and a shared memory 250. In one nonlimiting example, the controller 210 may include one or more processors, e.g., CPUs. Configuration data 202 associated with a given cell, e.g., cell 102, cell 104, cell 116, etc., may be received by the controller 210. The controller 210 may configure and allocate resources in the base station for the cells based on the configuration data 202.

Each of the components in FIG. 2 is a dedicated hardware block/component including one or more processors (e.g., microprocessors) and on-chip memory units storing software instructions. When the software instructions are executed by the processors, each of the hardware components becomes a special purposed hardware component for managing power and for executing job commands, as discussed in detail below. In some embodiments, the system as shown in FIG. 2 is on a single chip, e.g., a system-on-chip (SOC).

The shared memory 250, e.g., 96 MB, may be decomposed into smaller memory banks, e.g., 24 memory banks of 4 MB each. In this nonlimiting example, the shared memory 250 may be decomposed into a plurality of memory banks, e.g., memory banks 222A-222X where grouping of memory banks or each individual memory bank can be clock gated to turn off when not being utilized in order to reduce power consumption of the system. According to one nonlimiting example, a number of memory banks within the shared memory 250 may be grouped together and allocated to an uplink slot, downlink slot, or allocated as flexible slot that can dynamically be assigned to uplink or downlink as needed. The controller 210 may allocated certain number of memory banks of the shared memory 250 to downlink slots, a certain number of memory banks of the shared memory 250 to uplink slots, and a certain number of memory banks of the shared memory 250 to flexible slots, based on the configuration data 202. The share memory 250 may be used by one or more of the controller 210, DSPs 230, and accelerators 240.

In this example and for illustration purposes that should not be construed as limiting the scope of the embodiments, the controller 210 may group memory banks 222A-222F together and allocated it to a downlink slot as downlink memory banks 252 based on the configuration data 202. In one nonlimiting example, the controller 210 may group memory banks 222G-222L and allocate it to one uplink slot, group memory banks 222M-222R together and allocate it to another uplink slot, and group memory banks 222S-222X together and allocate it to yet another uplink slot, based on the configuration data 202, forming uplink memory banks 254. In other words, one row of the memory banks from the shared memory 250 is allocated to downlink slot whereas three rows of the memory banks from the shared memory 250 is allocated to three uplink slots. In this example, no memory bank is allocated to a flexible slot but in other example a number of memory banks may be grouped and assigned to a flexible slot. In some examples, 7 memory bank groups may be formed where each of them may be allocated to a downlink slot and 2 memory bank groups may be formed where each of them may be allocated to an uplink slot and 1 memory bank group may be formed that is allocated as a flexible slot.

It is appreciated that the number of memory banks within each group may vary. For example, the number of memory banks allocated (grouped) for one uplink slot may be different from another uplink slot. In other words, one group of memory banks allocated to an uplink slot may include 5 memory banks, as shown, and another group of memory banks may have a different number of memory banks, e.g., 3 memory banks, 4 memory banks, etc. It is appreciated, the number of memory banks allocated (grouped) in one downlink slot may be different from the number of memory bank in a different downlink slot. In other words, one group of memory banks allocated to a downlink slot may include 5 memory banks, as shown, and another group of memory banks allocated to another downlink slot (not shown here) may have a different number of memory banks, e.g., 3 memory banks, 4 memory banks, etc. Moreover, it is appreciated that the number of memory banks allocated (grouped) to a downlink slot may be different from the number of memory banks in an uplink slot. In other words, showing 5 memory banks per group is for illustrative purposes and should not be construed as limiting the scope of the embodiments. Moreover, it is appreciated that each memory bank may have the same capacity, e.g., 4 MB, or they may have a different capacity from one another, e.g., one memory bank may be 4 MB while another may be 16 MB.

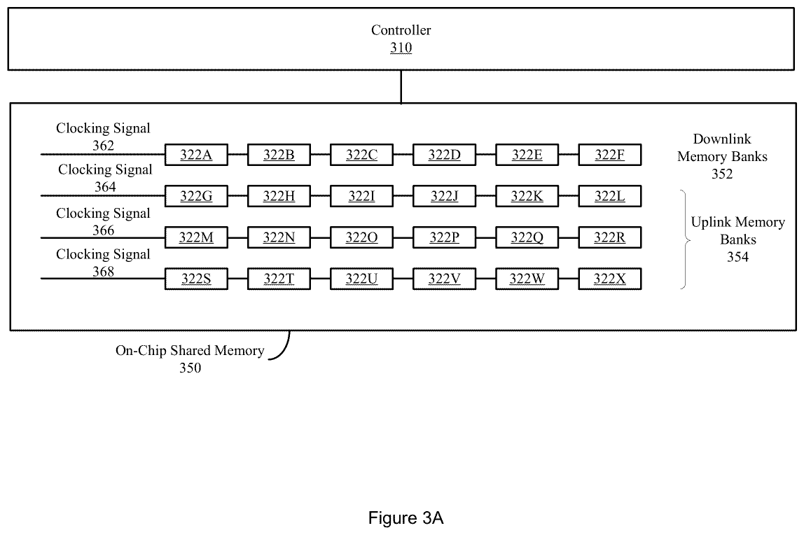

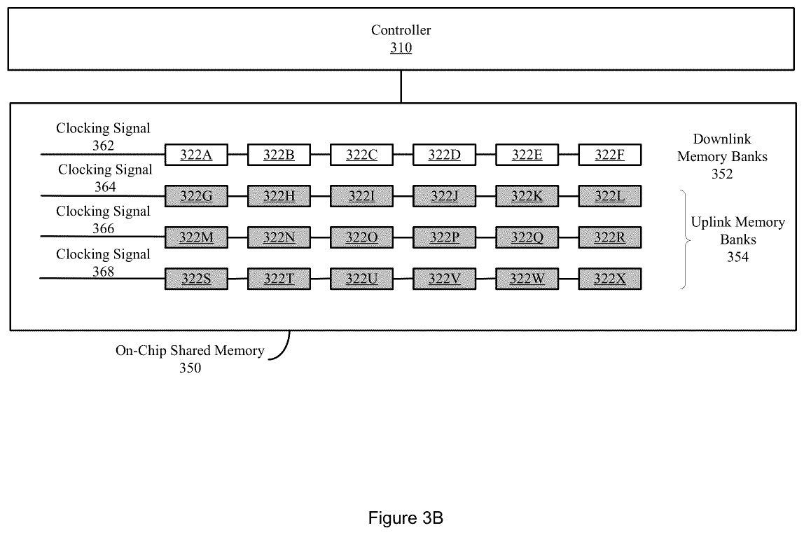

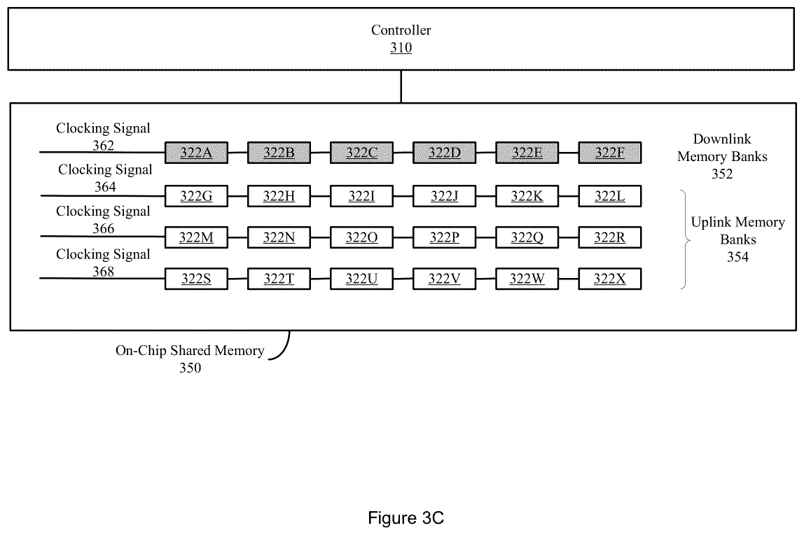

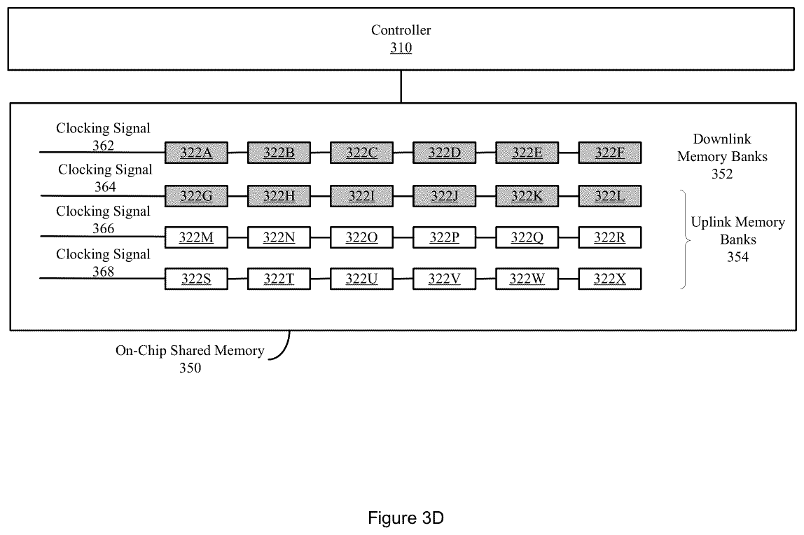

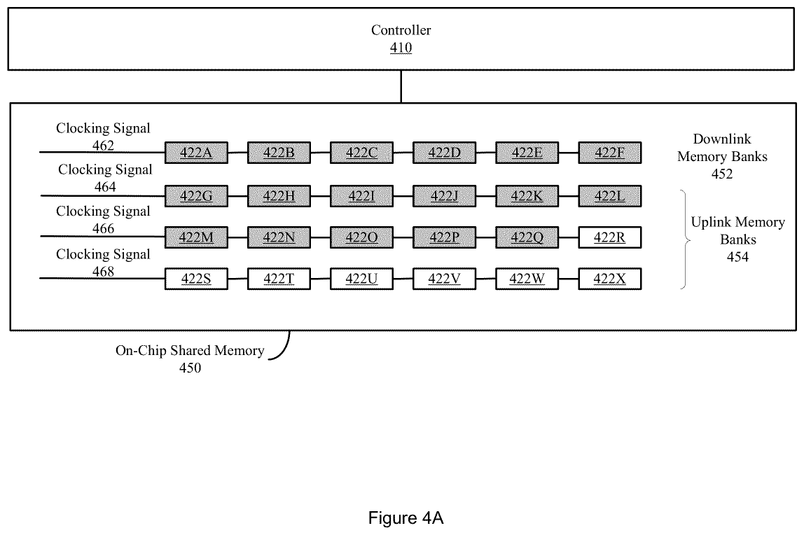

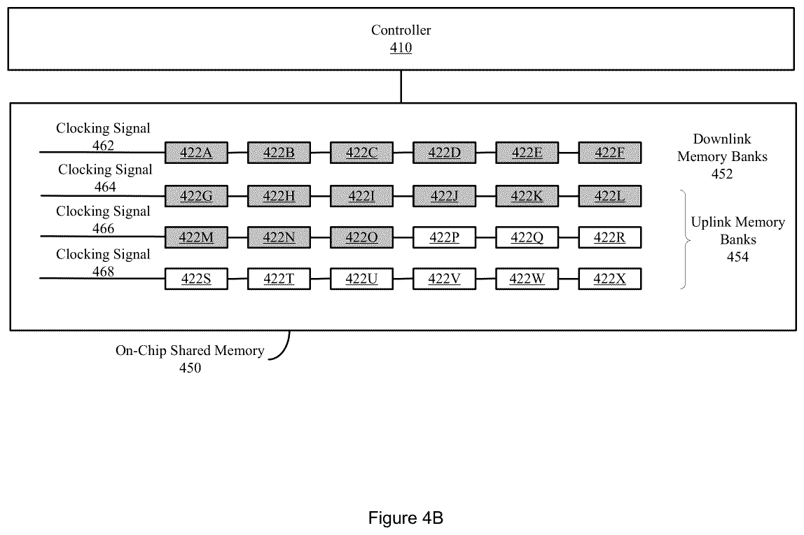

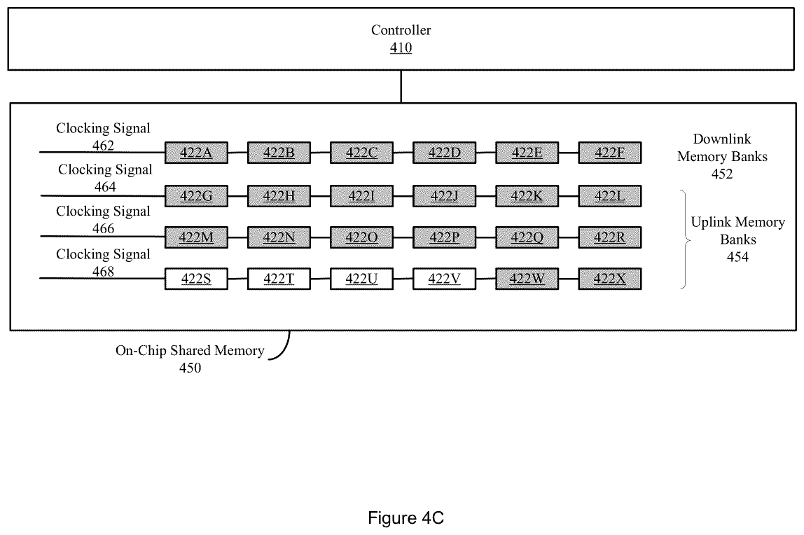

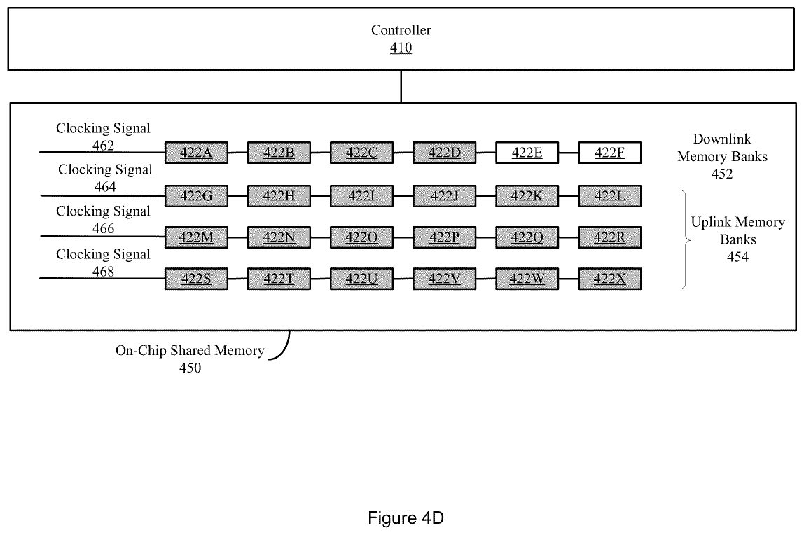

It is appreciated that in one nonlimiting example, each group of memory banks may have its own clocking signal. For example, memory banks 222A-222F may have their own clocking signal 262, while memory banks 222G-222L may have their own clocking signal 264, while memory banks 222M-222R may have their own clocking signal 266, and while memory banks 222S-222X may have their own clocking signal 268. Each group may be clocked off when not in use as described in greater detail with respect to FIGS. 3A-4D, described below, to manage their power consumption. For example, downlink memory banks 252 may be clocked off by turning off the clocking signal 262 when the base station is involved in uplink and uplink memory banks 254 may be clocked off by turning off the clocking signals 264-268 when the base station is involved in downlink. It is appreciated that in some nonlimiting example, each memory bank may be clocked independently if desired such that power consumption by the memory banks may be controlled in a more granular level. Variations for managing power are described in greater detail in FIGS. 3A-4D below.

According to some embodiments, once resources, e.g., memory banks, are allocated (as described above) based on the configuration data 202, the base station may begin processing data communications from the cells, e.g., cells 102-126. Data (PHY layer data) associated with a given slot may be received by the controller 210 from one or more of the cells 102-126. The controller 210 may process the received data (slot) and determine whether the data is for uplink or downlink. As such, unused memory banks may be clocked off in order to reduce power consumption. For example, if the controller 210 determines that the received data is for uplink then memory banks allocated for downlink slots may be powered off (e.g., by clocking them off) and if the controller 210 determines that the received data is for downlink then memory banks allocated for uplink slots may be powered off (e.g., by clocking them off), thereby reducing power consumption of the base station.

In some embodiments, the controller 210 may process the received data and generate and assign jobs for other processing components. In other words, signal processing may be offloaded from the controller 210 to other components, e.g., accelerators 240, DSPs 230, etc. For example, the controller 210 may assign certain jobs associated with the received slot to DSPs 230 and assign certain jobs associated with the received slot to the accelerators 240. It is appreciated that the accelerators 240 may be one or more hardware accelerators (e.g., field programmable gate array (FPGA), application specific integrated circuit (ASIC), etc.) configured to perform at least one or more operations associated with forward error correction (FEC) calculations, equalization, demapping, etc. It is appreciated that the DSPs 230 may include one or more DSP cores configured to perform at least one or more operations associated with channel estimation, demodulation reference (DMR) signal generation, frequency error calculations, timing estimation, etc.

It is appreciated that a subset of the accelerators from the accelerators 240 may be placed in a lower power mode when they are not being utilized (when idle) to reduce power consumption. Similarly, a subset of DSPs from the DSPs 230 may be placed in a lower power mode when they are not being utilized (idle) to reduce power consumption. The assigned jobs by the controller 210 are scheduled for the DSPs 230 and/or accelerators 240 using the scheduler 220.

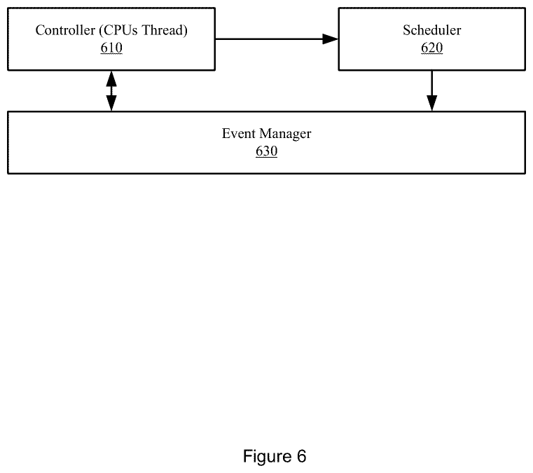

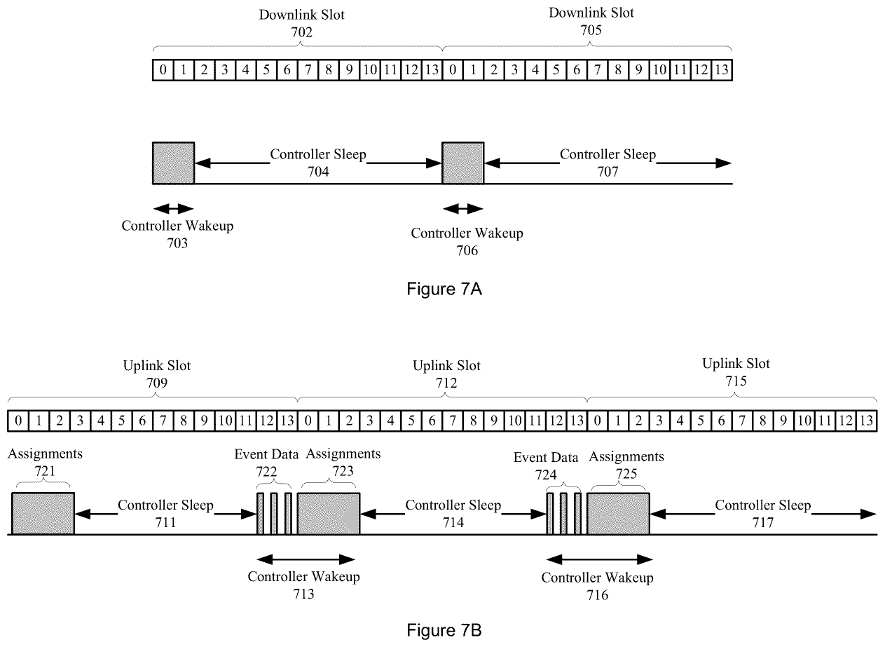

It is appreciated that in some embodiments certain event data 204 may be received by the scheduler 220 and/or controller 210. The event data 204 may be used to further manage power consumption by the controller 210 described in great detail in FIGS. 6-7B below.

It is appreciated that the base station may include other components that are not shown for brevity. For example, the base station may also include other memory components, e.g., DDR memory, one or more databases, etc.

Referring now to FIG. 3A, a nonlimiting example of allocation of memory banks to the slots is shown for illustrative purposes. In FIG. 3A, the controller 310 may be similar to that of controller 210 and the on-chip shared memory 350 may be similar to the shared memory 250. The memory banks 322A-322X are similar to memory banks 222A-222X of FIG. 2 and the clocking signals 362-368 are similar to the clocking signals 262-268. Memory banks 322A-322F may be grouped together and allocated to a downlink slot as downlink memory banks 352 while memory banks 322G-322L, memory banks 322M-322R, and memory banks 322S-322X are each allocated to an uplink slot as uplink memory banks 354.

Referring now to FIG. 3B, the data is received by the controller 310, from a cell, e.g., cell 102. The controller 310 may determine that the received data is for downlink. Since the system is deployed in a TTD system, data is either being transmitted or received but not both. Accordingly, it is determined that the memory banks 322A-322F allocated to downlink slot will be utilized whereas the uplink memory banks 354 will not be utilized since the received data indicates downlink. Thus, the memory banks 322G-322X are clocked off, e.g., using clocking signals 364-368, during the current slot since the slot is for downlink and not uplink. Clocking off the memory banks 322G-322X reduces the power consumption that would otherwise result in the power being wasted since the memory banks 322G-322X are not being used for the current slot being processed. Moreover, it is appreciated that in general uplink processing is more complex in nature and therefore more power consuming. As such, turning off the memory banks 322G-322X that are allocated to uplink, when the memory banks 322G-322X are not being used results in great power savings.

Referring now to FIG. 3C, the data is received by the controller 310, from a cell, e.g., cell 126. The controller 310 may determine that the received data is for uplink. Since the system is deployed in a TTD system, data is either being transmitted or received but not both. Accordingly, it is determined that the memory banks 322G-322X allocated to uplink slot will be utilized whereas the downlink memory banks 352 will not be utilized since the received data indicates uplink. Thus, the memory banks 322A-322F are clocked off, e.g., using clocking signal 362, during the current slot since the slot is for uplink and not downlink. Clocking off the memory banks 322A-322F reduces the power consumption that would otherwise result in the power being wasted since the memory banks 322A-322F are not being used for the current slot being processed.

Referring now to FIG. 3D, the data is received by the controller 310, from a cell, e.g., cell 126. The controller 310 may determine that the received data is for uplink. Since the system is deployed in a TTD system, data is either being transmitted or received but not both. Accordingly, it is determined that the memory banks 322G-322X allocated to uplink slot will be utilized whereas the downlink memory banks 352 will not be utilized since the received data indicates uplink. Moreover, the system may determine that not all of the memory banks in the uplink memory banks 354 will be used based on the load associated with the wireless network. For example, the controller 310 may determine that memory banks 322M-322X will be used for two uplink slots. In other words, it may be determined that memory banks 322G-322L in the uplink memory banks 354 are not needed even though the data being processed is associated with uplink. Thus, the memory banks 322A-322F from the downlink memory banks 352 are clocked off, e.g., using clocking signal 362, during the current slot since the slot is for uplink and not downlink, as well as clocking off memory banks 322G-322L since the memory banks 322G-322L allocated to uplink slot is not being used based on the load on the wireless network. Clocking off the memory banks 322A-322F as well as memory banks 322G-322L reduces the power consumption that would otherwise result in the power being wasted since the memory banks 322A-322L are not being used for the current slot being processed. In other words, power consumption is limited to memory banks that are being used, thereby reducing power consumption.

FIGS. 4A-4D depict an example of managing power associated with a shared memory in a dynamic configuration of a wireless network according to one aspect of the present embodiments. FIGS. 4A-4D illustrate power consumption for each memory bank being controllable in a more granular fashion. In FIG. 4A, the controller 410 may be similar to that of controller 310 and the on-chip shared memory 450 may be similar to the on-chip shared memory 350. The memory banks 422A-422X are similar to memory banks 322A-322X of FIG. 3 except that the power consumption by each memory bank is individually controlled by its respective clocking signals 462-468. Memory banks 422A-422F may be grouped together and allocated to a downlink slot as downlink memory banks 452 while memory banks 422G-422L, memory banks 422M-422R, and memory banks 422S-422X are each allocated to an uplink slot as uplink memory banks 454.

In this nonlimiting example, the data is received by the controller 410, from a cell, e.g., cell 102. The controller 410 may determine that the received data is for uplink. Since the system is deployed in a TTD system, data is either being transmitted or received but not both. Accordingly, it is determined that the memory banks 422A-422F allocated to downlink slot will not be utilized. As such, the memory banks 422A-422F may be clocked off using the clocking signal 462. Moreover, the controller 410 may determine that a subset of memory banks allocated to uplink slots may be needed, based on the load on the wireless network. Accordingly, the number of memory banks that may be needed is adjusted and the unused memory banks are clocked off to reduce power consumption. For example, it may be determined that memory banks 422G-422Q even though allocated to uplink slots are not needed based on the load and are therefore clocked off to reduce power consumption. It is appreciated that the clocking signals 464 and 466 may be used to clock off the memory banks 422G-422Q during the processing of the current slot, thereby reducing power consumption. Clocking off the memory banks 422G-422Q reduces the power consumption that would otherwise results in the power being wasted since the memory banks 422G-422Q are not being used for the current slot being processed.

FIG. 4B is substantially similar to that of FIG. 4A except that the controller 410 determines that a higher load on the wireless network in comparison to FIG. 4A. As such, more memory banks are needed for processing the current slot associated with uplink. In this nonlimiting example, the memory banks 422G-4220 are clocked off to reduce power consumption because they are not needed for processing the current slot in addition to the downlink memory banks 452 being clocked off.

FIG. 4C is substantially similar to that of FIG. 4A except that the controller 410 determines a lighter load on the wireless network in comparison to FIG. 4A. As such, fewer memory banks are needed for processing the current slot associated with uplink. In this nonlimiting example, the memory banks 422G-422R and 422W-422X are clocked off to reduce power consumption because they are not needed for processing the current slot in addition to the downlink memory banks 452 being clocked off.

FIG. 4D is substantially similar to FIG. 4A. In this nonlimiting example, the data is received by the controller 410, from a cell, e.g., cell 102. The controller 410 may determine that the received data is for downlink. Since the system is deployed in a TTD system, data is either being transmitted or received but not both. Accordingly, it is determined that the memory banks 422G-422X allocated to uplink slot will not be utilized. As such, the memory banks 422G-422X may be clocked off using the clocking signal 464-468. Moreover, the controller 410 may determine that a subset of memory banks allocated to downlink slot may be needed, based on the load on the wireless network. Accordingly, the number of memory banks that may be needed is adjusted and the unused memory banks are clocked off to reduce power consumption. For example, it may be determined that memory banks 422A-422D even though allocated to a downlink slot, are not needed based on the load and are therefore clocked off to reduce power consumption. It is appreciated that the clocking signal 462 may be used to clock off the memory banks 422A-422D during the processing of the current slot, thereby reducing power consumption. Clocking off the memory banks 422A-422D and 422G-422X reduces the power consumption that would otherwise results in the power being wasted since the memory banks 422A-422D and 422G-422X are not being used for the current slot being processed.

It is appreciated that FIGS. 3A-4D describe controlling power consumption of the memory banks using the clocking signals for illustrative purposes that should not be construed as limiting the scope of the embodiments. For example, the clocking signal may be used along with a gate logic to control powering up the memory banks or to powering down the memory banks.

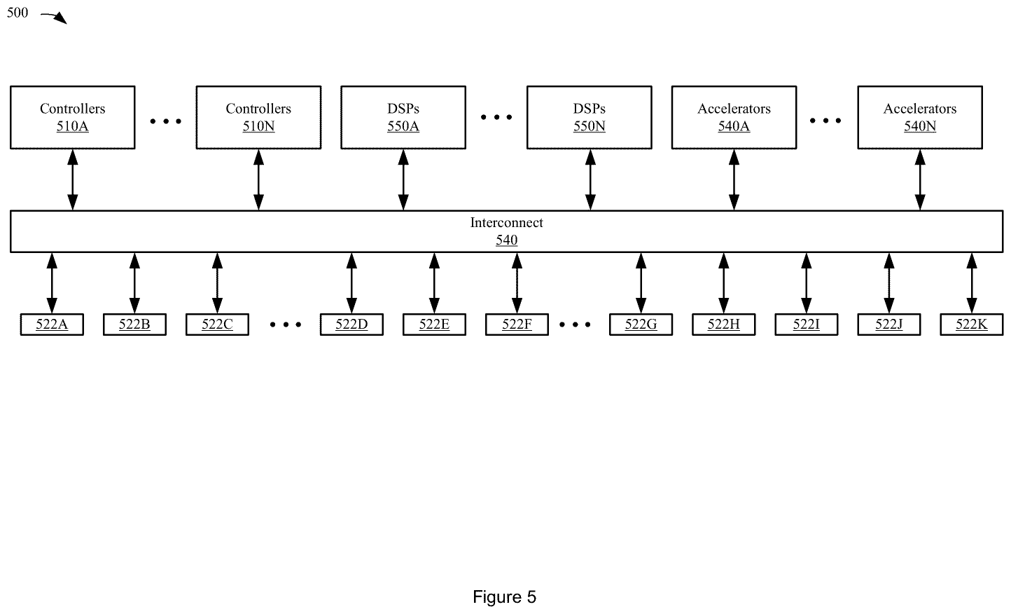

FIG. 5 depicts an example of base station 500 with shared memory for processing data according to one aspect of the present embodiments. The base station 500 may include one or more controllers 510A-510N, one or more DSPs 550A-550N, one or more accelerators 540A-540N, and a shared memory, e.g., 96 MB, which is decomposed into a plurality of memory banks 522A-522K. It is appreciated that the one or more controllers 510A-510N, the one or more DSPs 550A-550N, the one or more accelerators 540A-540N, and the plurality of memory banks 522A-522K may be coupled to one another via an interconnect 540, e.g., InterconnectX. It is appreciated that controller 510A may include multiple controllers, e.g., CPUs. Similarly, each of the controllers 510B-510N may each include multiple controllers. It is further appreciated that DSPs 550A may include multiple DSPs. Similarly, each of the DSPs 550B-550N may include multiple DSPs. Moreover, it is appreciated that accelerators 540A may include multiple accelerators, e.g., FPGAs, ASICs, etc. Similarly, each accelerator 540B-540N may include multiple accelerators. It is appreciated that the DSPs, accelerators, controllers, and memory banks of FIG. 5 may be similar to those described in FIGS. 2-4D. Moreover, it is appreciated that each controller, each DSP, each accelerator, and each memory bank may be clocked off (placed in a lower power mode) when not needed, as described above, thereby reducing power consumption. It is appreciated that the memory banks 522A-522K may each be a 4 MB memory. It is further appreciated that in some nonlimiting example the size of at least two of the memory banks may be different from one another, e.g., one may be 4 MB and another may be 8 MB.

As described above, the shared memory utilization varies based on number of cells and bandwidth that is supported (i.e., based on load on the wireless network). In one nonlimiting example of TDD, at 20 MHz bandwidth and 18 cells with 7 downlink slots and 3 uplink slots, the embodiments described above enable 14 uplink banks clock to gated for approximately 70% of the time, thereby providing significant power saving associated with PHY layer processing. Reduction in power consumption using the embodiments described above may range from approximately 26% savings in uplink to approximately 62% for downlink with an average saving of approximately 52%.

It is appreciated that time is critical in 5G wireless network and that the system (e.g., base station) may have very limited time budget to parse the received data of the configured cells and to create jobs appropriately. As such, a combination of accelerators and/or DSPs may be used, as described above. As one nonlimiting example, the PHY configured with 15 kHz subcarrier spacing has a 1 ms time slot for the processing and the next 1 ms slot to transmit or receive 14 OFDM symbols over the air. The allocated time slot is further reduced by increasing the subcarrier spacing, e.g., time slot becomes half for subcarrier spacing increasing to 30 kHz. In order to manage the limited time budget, the PHY layer processing may utilize two sub-systems. The first sub-system may include the DSPs, accelerators, shared memory, etc., as described above. The second sub-system may include a CPU sub-system as described in FIG. 6 below.

FIG. 6 depicts an example of a processing unit of a base station in a wireless network according to one aspect of the present embodiments. The processing unit may include controller 610 (CPU threads), a scheduler 620, and an event manager 630. The controller 610 may be one or more of the controllers as described in FIGS. 2-5. The controller 610 receives data in the wireless network. The controller 610 is configured to process the data in a first power mode (e.g., fully powered on mode) and based on that processing may assign a first set of jobs to at least one or more accelerators and/or may assign a second set of jobs to at least or more DSPs. It is appreciated that the accelerators and the DSPs are similar to those described in FIGS. 2-5. Once the assignment of jobs for processing is complete (i.e., once processing the data by the controller 610 is complete), the job assignments are sent to the scheduler 620 for scheduling for execution by the accelerators and/or DSPs.

It is appreciated that since the controller 610 is complete with its processing for the current data (e.g., assigning the jobs to DSPs and/or accelerators), it is transitioned to a second power mode (e.g., sleep mode) that is at a lower power mode than that of the first power mode. According to one nonlimiting example, the event manager 630 manages power modes associated with the controller 610. In one nonlimiting example, the event manager 630 transitions the controller 610 into the second power mode and in another nonlimiting example, the controller 610 transitions into the second power mode automatically. It is appreciated that in one nonlimiting example, the event manager 630 is further configured to transition the controller 610 from the second power mode to the first power mode (to wakeup the controller 610) in response to a triggering event, e.g., interrupt, expiration of a configurable amount of time, etc.

Managing power consumption of the controller 610 with respect to a downlink processing is described with respect to the nonlimiting example in FIG. 7A. In FIG. 7A, data associated with downlink slot 702 is received followed by the next set of data associated with downlink slot 705. The controller 610 processes the data associated with downlink slot 702. In one nonlimiting example, the controller 610 is woken up by the event manager 630 when data is received so that the data can be processed (if the controller 610 is in a sleep mode). In this nonlimiting example, the controller 610 may process the data (e.g., parse the received data) within an amount of time for two symbols (i.e., the controller 610 is awake during controller wakeup 703) and to create/assign jobs associated with the data in the downlink slot 702 to the DSPs and/or accelerators.

The job assignments are sent to the scheduler 620 to be scheduled for execution by the DSPs and/or accelerators. For example, the created/assigned jobs may be queued in a queue within the scheduler 620. Since the controller 610 is complete with its processing (i.e., parsing and assigning/creating jobs for the accelerators and/or DSPs), it is transitioned from the first power mode to the second power mode by the event manager 630. As such, the controller 610 remains in the second power mode (i.e., controller sleep 704) until a triggering event occurs. In this nonlimiting example, the triggering event is receiving data associated with downlink slot 705 and may be a generated interrupt. As such, the event manager 630 wakes the controller 610 up to process data associated with downlink slot 705. In this nonlimiting example, the controller 610 is awake during controller wakeup 706 that it takes to process data associated with the downlink slot 705 (i.e., the amount of time it takes to assign jobs associated with data in the downlink slot 705 to DSPs and/or accelerators). Once the assignment of jobs associated with data in the downlink slot 705 is determined by the controller 610, the event manager 630 transitions the controller 610 to the second power mode, similar to above. As illustrated, the controller 610 spends a significant amount of time in the second power mode (e.g., an amount of time associated with 12 symbols) and is awake for only enough time to complete its processing (e.g., parsing and assigning/creating jobs for the DSPs and/or accelerators that may take approximately 2 symbols). As such, power consumed by the controller 610 is significantly reduced. This results in even more significant power reduction since there are typically multiple controllers in the system, e.g., 6 controllers, etc. It is appreciated that downlink slots are processed 70% of the time and as such the power management of the controller 610 described above results in significant power reduction.

It is appreciated that the example above described the triggering event being an interrupt generated as a result of receiving new data. However, it is appreciated that the triggering event may be expiration of a configured amount of time. For example, the controller 610 may be transitioned into the second power mode for a configured amount of time (e.g., an amount of time that is configurable) and that it is transitions out from the second power mode into the first power mode when the configured amount of time is expired. In one nonlimiting example, the triggering event may be expiration of the configured amount of time or an interrupt that is generated, whichever occurs first. In other words, the controller 610 remains in the second power mode and transitions to the first power mode after the expiration of the configured amount of time in absence of a triggering event, e.g., an interrupt, or it may transition to the first power mode before the expiration of the configured amount of time if an interrupt is received before the expiration of the configured amount of time. In one nonlimiting example, an interrupt may be associated with a timed report that is described with respect to FIG. 7B with respect to uplink data.

Referring now to FIG. 7B, managing power consumption of the controller 610 with respect to an uplink processing is described. In this example, data associated with uplink slot 709 is received followed by data associated with uplink slot 712 and 715 respectively. Each uplink slot includes 14 symbols for illustration purposes. It is appreciated that according to one nonlimiting example, the controller 610 may process uplink data that may take approximately 3 symbols (3 symbols long). For example, the controller 610 may take up to 3 symbols to parse the received data and to assign/create jobs (i.e., assignments 721) associated with the data in the uplink slot 709 to the one or more DSPs and/or one or more accelerators. The assigned/created jobs may be sent to the scheduler 620 (e.g., queued in a queue within the scheduler 620) to be scheduled for execution by the one or more DSPs and/or one or more accelerators. As such, after the first 3 symbols of data in uplink slot 709, the controller 610 is transitioned from the first power mode into the second power mode, by the event manager 630. In one example, the controller 610 is transitioned from the first power mode into the second power mode until a triggering event occurs, e.g., expiration of a configure amount of time, interrupt, event data, etc. In this example, the controller 610 remains in the second power mode for controller sleep 711 time, which in this example is for amount of time equivalent to 9 symbols long. Event data 722 may be generated, e.g., by one or more of the DSPs and/or one or more of the accelerators, etc., associated with processing their respective data that was scheduled for execution prior to the data associated with uplink slot 709. The event data 722 may include a time report in one nonlimiting example and it may take equivalent to 2 symbols long.

The event data 722 causes an interrupt to be generated to wake up the controller 610, e.g., transitioning the controller 610 from the second power mode into the first power mode. The event data 722 may be followed by the next set of data associated with the uplink slot 712. As such, the controller 610 spends another 3 symbols in length to parse data associated with the uplink slot 712 and to assign/create jobs for the one or more accelerators and/or one or more DSPs. The assigned/created jobs are sent to the scheduler 620 (e.g., queued in its queue) to be scheduled for execution by the DSPs and/or accelerators, as described above. In one nonlimiting example, the controller 610 remains in the first power mode for a controller wakeup 713 amount of time (equivalent to 5 symbols) to process the event data 722 and to process data associated with the uplink slot 712. It is appreciated that since the controller 610 is complete with processing of data associated with uplink slot 712, it is transitioned from the first power mode into the second power mode by the event manager 620.

The controller 610 remains in the second power mode for a controller sleep 714 time (9 symbols long in this example) until a next triggering event occurs, e.g., interrupt, event data, new data for the next uplink slot, expiration of configured amount of time, etc. In this nonlimiting example, event data 724 generated by one or more of the DSPs and/or one or more of the accelerators associated with the data processing for uplink slot 709 may be received. As such, an interrupt may be generated to transition the controller 610 from the second power mode into the first power mode. Similar to before the next set of data associated with uplink slot 715 is received and is parsed and jobs are created/assigned by the controller 610 to the one or more of the accelerators and/or DSPs. In other words, the controller 610 remains in the first power mode for a controller wakeup 716 time (5 symbols long in this example) before it is transitioned into the second power mode by the event manager 620 for controller sleep 717 time.

As illustrated in FIGS. 7A and 7B, the controller spends a significant amount of time in a lower power mode in comparison to the conventional system that was always on regardless of whether it was processing data or not. As a result, power consumed by the controller is significantly reduced.

It is appreciated that the power management associated with the controller as described in FIGS. 6-7B may operate in a polling mode or an interrupt mode. In polling mode, the controller 610 may call the event manager 630 to poll for events, e.g., expiration of configured amount of time, time report generated by DSPs and/or accelerators, etc. After placing the call with the event manager 630, the controller 610 may transition into the second power mode (e.g., sleep mode) for a configured amount of time. During the configured amount of time, the controller 610 remains in the second power mode if no triggering event occurs other than the expiration of the configured amount of time, at which point the controller 610 transitions back into the first power mode. The controller 610 at that point may process any pending tasks and transition into the second power mode when the processing is done. It is appreciated that if no task is pending when the controller 610 transitions from the second power mode into the first power mode, it is transitioned back into the second power mode. The process may repeat itself. However, if a triggering event other than expiration of configured time occurs, then the controller 610 is transitioned into the first power mode, by the event manager 630, prior to the expiration of the configured amount of time. When in the first power mode, the controller 610 processes any pending requests and transitions back into the second power mode when complete. The process repeats itself.

In contrast, in an interrupt mode, the controller 610 transitions itself from the first power mode into the second power mode when it is complete with its processing (e.g., parsing data and assigning/creating jobs for one or more of DSPs and/or accelerators). The controller 610 may remain in the second power mode until an interrupt is received by the event manager 630. The event manager 630 wakes up the controller 610 (i.e., transitions the controller 610 from the second power mode into the first power mode). The controller 610 may complete processing of any pending tasks and may transition itself back into the second power mode when it is complete with its processing. The process may repeat itself.

The embodiments described in FIGS. 6-7B result in reduction of power consumption of approximately 85% for downlink and approximately 60% for uplink with an average reduction of approximately 78%.

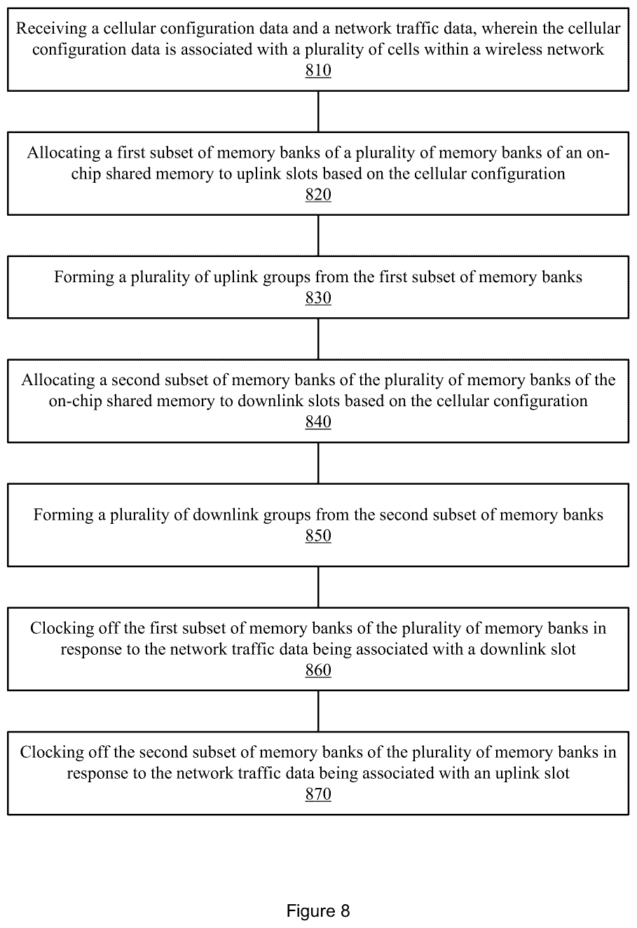

FIG. 8 depicts an illustrative flow diagram for managing power associated with a shared memory in a processor of a base station according to one aspect of the present embodiments. At step 810, a cellular configuration data and a network traffic data is received, as described above in FIGS. 1-5. The cellular configuration data is associated with a plurality of cells within a wireless network, as described in FIGS. 1-5. At step 820, a first subset of memory banks of a plurality of memory banks of an on-chip shared memory is allocated to uplink slots based on the cellular configuration, as described in FIGS. 1-5. At step 830, a plurality of uplink groups (e.g., rows) is formed from the first subset of memory banks, as described above. In one nonlimiting example, an uplink group may include one memory bank. At step 840, a second subset of memory banks of the plurality of memory banks of the on-chip shared memory is allocated to downlink slots based on the cellular configuration, as described above with respect to FIGS. 1-5. At step 850, a plurality of downlink groups is formed from the second subset of memory banks, as described above. In one nonlimiting example, a downlink group may include one memory bank. At step 860, the first subset of memory banks of the plurality of memory banks is clocked off in response to the network traffic data being associated with a downlink slot, as described above. At step 870, the second subset of memory banks of the plurality of memory banks is clocked off in response to the network traffic data being associated with an uplink slot, as described above.

It is appreciated that in some embodiments, a subset of uplink groups of the plurality of uplink groups is clocked off based on a load associated with the network traffic data and in response to the network traffic data being associated with a downlink slot. In some embodiments, a subset of downlink groups of the plurality of downlink groups is clocked off based on a load associated with the network traffic data and in response to the network traffic data being associated with an uplink slot.

In some embodiments, a third subset of memory banks of the plurality of memory bank is allocated as a flexible slot that is configured as an uplink slot or a downlink slot depending on the load associated with the network traffic. The wireless network may be deployed in a TDD, as described above. It is appreciated that the number of memory banks in each uplink group may be the same or different from one another. It is further appreciated that the number of memory banks in each downlink group may be the same or different from one another. Moreover, the number of memory banks in one uplink group may be the same or different from one downlink group.

It is appreciated that the method may include processing a physical layer of the network traffic data. In one nonlimiting example, the method may further include determining whether the traffic data is associated with uplink or downlink. In some embodiments, the method also includes scheduling a first plurality of jobs for one or more hardware accelerators and scheduling a second plurality of jobs for one or more DSP cores, and wherein the one or more DSP cores is configured to perform at least one or more operations associated with channel estimation. The hardware accelerators may be configured to perform at least one or more operations associated with FEC calculations, equalization, and demapping. The DSP cores may be configured to perform one or more of DMR signal generation, frequency error calculations, and timing estimation.

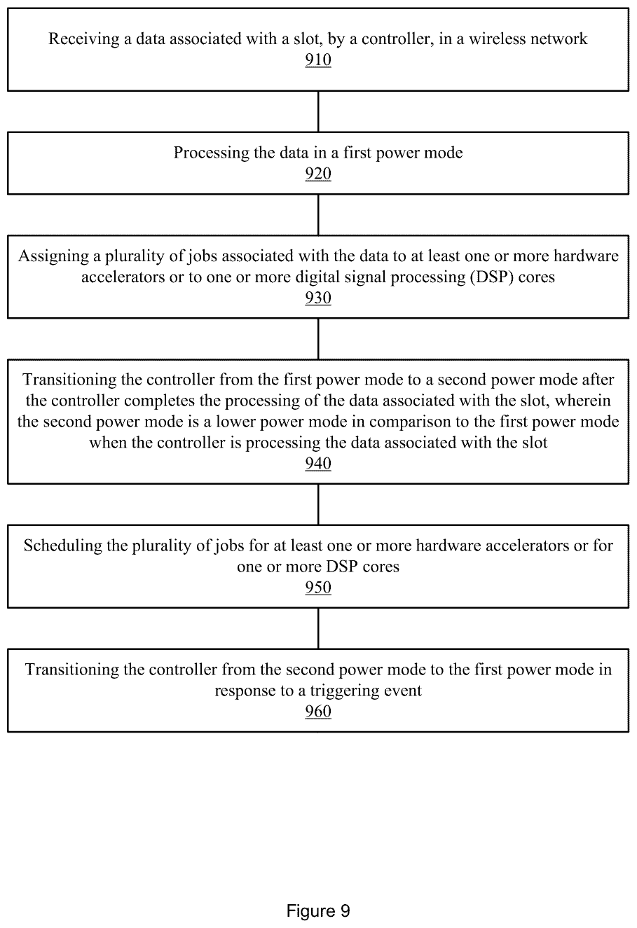

FIG. 9 depicts an illustrative flow diagram for managing power associated with a processor of a base station according to one aspect of the present embodiments. At step 910, a data associated with a slot is received, by a controller, in a wireless network, as described in FIGS. 1, and 6-7B. the wireless network may be deployed in a TTD. At step 920, the data is processed in a first power mode, as described in FIGS. 1, and 6-7B. At step 930, a plurality of jobs associated with the data is assigned to at least one or more hardware accelerators or to one or more DSP cores, as described in FIGS. 1, and 6-7B. At step 940, the controller is transitioned from the first power mode to a second power mode after the controller completes the processing of the data associated with the slot, as described in FIGS. 1, and 6-7B. It is appreciated that the second power mode is a lower power mode in comparison to the first power mode when the controller is processing the data associated with the slot. At step 950, the plurality of jobs is scheduled for at least one or more hardware accelerators or for one or more DSP cores, as described in FIGS. 1, and 6-7B. At step 960, the controller is transitioned from the second power mode to the first power mode in response to a triggering event, as described in FIGS. 1, and 6-7B.

It is appreciated that the data may be a downlink data and wherein the slot is a downlink slot. It is appreciated that the triggering event may be associated with receiving another data associated with another slot in the wireless network, as described in FIGS. 1, and 6-7B.

It is appreciated that the data may be an uplink data and wherein the slot is an uplink slot. According to some nonlimiting examples, the triggering event is receiving data associated with a subset of jobs associated with the plurality of jobs for the at least one or more hardware accelerators or associated with another subset of jobs associated with the plurality of jobs for the one or more DSP cores, as described in FIGS. 1, and 6-7B.

In some embodiments, the controller is transitioned from the first power mode to the second power mode for a configured amount of time. It is appreciated that transitioning the controller from the second power mode to the first power mode may be in response to expiration of the configured amount of time and further in response to absence of receiving the triggering event. In one nonlimiting example, the method further includes the controller requesting a polling after the controller is transitioned into the first power mode and wherein in absence of the triggering event the controller is transitioned from the first power mode to the second power mode. It is appreciated that the controller may transition from the second power mode to the first power mode during the configured amount of time and in response to receiving the triggering event.

In some embodiments, the controller remains in the second power mode until an interrupt is generated and sent to the controller to transition the controller from the second power mode to the first power mode. In one nonlimiting example, the method includes processing a subset of jobs of the plurality of jobs by the at least one or more hardware accelerators and processing another subset of jobs of the plurality of jobs by the one or more DSP cores. As described above, the one or more hardware accelerators are configured to perform at least one or more operations associated with FEC calculations, equalization, and demapping, and wherein the one or more DSP cores are configured to perform at least one or more operations associated with channel estimation, DMR signal generation, frequency error calculations, and timing estimation.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Embodiments were chosen and described in order to best describe the principles of the invention and its practical application, thereby enabling others skilled in the relevant art to understand the claimed subject matter, the various embodiments and the various modifications that are suited to the particular use contemplated.

What is claimed is:

1. A system, comprising:
a controller configured to receive a cellular configuration data and a network traffic data, wherein the cellular configuration data is associated with a plurality of cells within a wireless network; and
an on-chip shared memory that is configured based on the cellular configuration data into a plurality of memory bank groups, wherein each memory bank group of the plurality of memory bank groups includes a number of memory banks, and wherein a first subset of memory bank groups of the plurality of memory bank groups is associated with an uplink slot, and wherein a second subset of memory bank groups of the plurality of memory bank groups is associated with a downlink slot,
wherein the first subset of memory bank groups associated with the uplink slot is clocked off in response to the network traffic data being associated with a downlink slot, and wherein the second subset of memory bank groups associated with the downlink slot is clocked off in response to the network traffic data being associated with an uplink slot.

2. The system of claim 1, wherein a third subset of memory bank groups of the plurality of memory bank groups that is associated with a flexible slot is configured as an uplink slot or a downlink slot depending on load associated with the network traffic.

3. The system of claim 1, wherein the controller and the on-chip shared memory are within a base station deployed in a time division duplex (TDD).

4. The system of claim 1, wherein the number of memory banks for each group within the first subset of memory bank groups is the same.

5. The system of claim 1, wherein the number of memory banks for each group within the second subset of memory bank groups is the same.

6. The system of claim 1, wherein the controller and the on-chip shared memory are within a physical card of a base station configured to process a physical layer of the network traffic data.

7. The system of claim 6, wherein the physical card is a Peripheral Component Interconnect (PCI) card.

8. The system of claim 1 further comprising one or more hardware accelerators and one or more digital signal processing (DSP) cores, wherein the controller is configured to schedule one or more jobs for the one or more hardware accelerators and the one or more DSP cores, wherein the one or more hardware accelerators is configured to perform at least one or more operations associated with forward error correction (FEC) calculations, equalization, and demapping, and wherein the one or more DSP cores is configured to perform at least one or more operations associated with channel estimation, demodulation reference (DMR) signal generation, frequency error calculations, and timing estimation.

9. A system, comprising:
a controller configured to receive a cellular configuration data and a network traffic data, wherein the cellular configuration data is associated with a plurality of cells within a wireless network; and
an on-chip shared memory including a plurality of memory banks,
wherein a first subset of memory banks of the plurality of memory banks is allocated to uplink slots based on the cellular configuration, and wherein the first subset of memory banks
wherein a second subset of memory banks of the plurality of memory banks is allocated to downlink slots based on the cellular configuration, and wherein the second subset of memory banks includes a plurality of downlink groups,
wherein the first subset of memory banks allocated to uplink slots is clocked off in response to the network traffic data being associated with a downlink slot, and wherein a subset of uplink groups of the plurality of uplink groups is clocked off in response to load associated with downlink data of the network data,
wherein the second subset of memory banks allocated to downlink slots is clocked off in response to the network traffic data being associated with an uplink slot, and wherein a subset of downlink groups of the plurality of downlink groups is clocked off in response to load associated with uplink data of the network data.

10. The system of claim 9, wherein a third subset of memory banks of the plurality of memory bank is associated with a flexible slot that is configured as an uplink slot or a downlink slot depending on the load associated with the network traffic.

11. The system of claim 9, wherein the controller and the on-chip shared memory are within a base station deployed in a time division duplex (TDD).

12. The system of claim 9, wherein a number of memory banks for each group within the plurality of uplink groups is the same.

13. The system of claim 9, wherein a number of memory banks for each group within the plurality of downlink groups is the same.

14. system of claim 9, wherein the controller and the on-chip shared memory are within a physical card of a base station configured to process a physical layer of the network traffic data.

15. The system of claim 14, wherein the physical card is a Peripheral Component Interconnect (PCI) card.

16. system of claim 9 further comprising one or more hardware accelerators and one or more digital signal processing (DSP) cores, wherein the controller is configured to schedule one or more jobs for the one or more hardware accelerators and the one or more DSP cores, wherein the one or more hardware accelerators is configured to perform at least one or more operations associated with forward error correction (FEC) calculations, equalization, and demapping, and wherein the one or more DSP cores is configured to perform at least one or more operations associated with channel estimation, demodulation reference (DMR) signal generation, frequency error calculations, and timing estimation.

17. The system of claim 9, wherein each uplink group of the plurality of uplink groups includes a number of memory banks of the first subset of memory banks.

18. The system of claim 17, wherein the number of memory banks is one.

19. The system of claim 9, wherein each downlink group of the plurality of downlink groups includes a number of memory banks of the second subset of memory banks.

20. The system of claim 19, wherein the number of memory banks is one.

21. A method, comprising:
receiving a cellular configuration data and a network traffic data, wherein the cellular configuration data is associated with a plurality of cells within a wireless network;
allocating a first subset of memory banks of a plurality of memory banks of an on-chip shared memory to uplink slots based on the cellular configuration;
forming a plurality of uplink groups from the first subset of memory banks;
allocating a second subset of memory banks of the plurality of memory banks of the on-chip shared memory to downlink slots based on the cellular configuration;
forming a plurality of downlink groups from the second subset of memory banks;
clocking off the first subset of memory banks of the plurality of memory banks in response to the network traffic data being associated with a downlink slot; and
clocking off the second subset of memory banks of the plurality of memory banks in response to the network traffic data being associated with an uplink slot.

22. The method of claim 21 further comprising:
in response to the network traffic data being associated with a downlink slot, clocking off a subset of uplink groups of the plurality of uplink groups based on a load associated with the network traffic data.

23. The method of claim 22, wherein each group of the plurality of uplink groups includes one memory bank.

21. The method of claim 21 further comprising:
in response to the network traffic data being associated with an uplink slot, clocking off a subset of downlink groups of the plurality of downlink groups based on a load associated with the network traffic data.

25. The method of claim 24, wherein each group of the plurality of downlink groups includes one memory bank.

26. The method of claim 21 further comprising allocating a third subset of memory banks of the plurality of memory bank as a flexible slot that is configured as an uplink slot or a downlink slot depending on the load associated with the network traffic.

27. The method of claim 21, wherein the wireless network is deployed in a time division duplex (TDD).

28. The method of claim 21, wherein a number of memory banks in each uplink group of the plurality of uplink groups is the same.

29. The method of claim 21, wherein a number of memory banks in one uplink group of the plurality of uplink groups is different from a number of memory banks in another uplink group of the plurality of uplink groups.

30. The method of claim 21, wherein a number of memory banks for each downlink group within the plurality of downlink groups is the same.

31. The method of claim 21, wherein a number of memory banks in one downlink group of the plurality of downlink groups is different from a number of memory banks in another downlink group of the plurality of downlink groups.

32. The method of claim 21 further comprising processing a physical layer of the network traffic data.

33. The method of claim 21 further comprising:
scheduling a first plurality of jobs for one or more hardware accelerators, wherein the one or more hardware accelerators is configured to perform at least one or more operations associated with forward error correction (FEC) calculations, equalization, and demapping; and
scheduling a second plurality of jobs for one or more digital signal processing (DSP) cores, and wherein the one or more DSP cores is configured to perform at least one or more operations associated with channel estimation, demodulation reference (DMR) signal generation, frequency error calculations, and timing estimation.

34. The method of claim 21 further comprising determining whether the traffic data is associated with uplink or downlink.

35. A system comprising:
a means for receiving a cellular configuration data and a network traffic data, wherein the cellular configuration data is associated with a plurality of cells within a wireless network;
a means for allocating a first subset of memory banks of a plurality of memory banks of an on-chip shared memory to uplink slots based on the cellular configuration;
a means for forming a plurality of uplink groups from the first subset of memory banks;
a means for allocating a second subset of memory banks of the plurality of memory banks of the on-chip shared memory to downlink slots based on the cellular configuration;
a means for forming a plurality of downlink groups from the second subset of memory banks;
a means for clocking off the first subset of memory banks of the plurality of memory banks in response to the network traffic data being associated with a downlink slot; and
a means for clocking off the second subset of memory banks of the plurality of memory banks in response to the network traffic data being associated with an uplink slot.

36. The system of claim 35 further comprising:
a means for clocking off a subset of uplink groups of the plurality of uplink groups based on a load associated with the network traffic data and in response to the network traffic data being associated with a downlink slot.

37. The system of claim 36, wherein each group of the plurality of uplink groups includes one memory bank.

38. The system of claim 35 further comprising:
a means for clocking off a subset of downlink groups of the plurality of downlink groups based on a load associated with the network traffic data and in response to the network traffic data being associated with an uplink slot.

39. The system of claim 38, wherein each group of the plurality of downlink groups includes one memory bank.

40. The system of claim 35 further comprising a means for allocating a third subset of memory banks of the plurality of memory bank as a flexible slot that is configured as an uplink slot or a downlink slot depending on the load associated with the network traffic.

41. The system of claim 35, wherein the wireless network is deployed in a time division duplex (TDD).

42. The system of claim 35, wherein a number of memory banks in each uplink group of the plurality of uplink groups is the same.

43. The system of claim 35, wherein a number of memory banks in one uplink group of the plurality of uplink groups is different from a number of memory banks in another uplink group of the plurality of uplink groups.

44. The system of claim 35, wherein a number of memory banks for each downlink group within the plurality of downlink groups is the same.

45. The system of claim 35, wherein a number of memory banks in one downlink group of the plurality of downlink groups is different from a number of memory banks in another downlink group of the plurality of downlink groups.

46. The system of claim 35 further comprising a means for processing a physical layer of the network traffic data.

47. The system of claim 35 further comprising:
a means for scheduling a first plurality of jobs for one or more hardware accelerators, wherein the one or more hardware accelerators is configured to perform at least one or more operations associated with forward error correction (FEC) calculations, equalization, and demapping; and
a means for scheduling a second plurality of jobs for one or more digital signal processing (DSP) cores, and wherein the one or more DSP cores is configured to perform at least one or more operations associated with channel estimation, demodulation reference (DMR) signal generation, frequency error calculations, and timing estimation.
